(19) United States
(12) Patent Application Publication
(10) Pub. No.: US 2017/0118020 A1
(43) Pub. Date: Apr. 27, 2017

(54) DATA COMMUNICATION METHOD, SYSTEM AND GATEWAY FOR IN-VEHICLE NETWORK INCLUDING A PLURALITY OF SUBNETS

(71) Applicant: Leauto Intelligent Technology (BEIJING) Co. Ltd., Beijing (CN)

(72) Inventors: Yong Xu, Beijing (CN); Kunsheng Chen, Beijing (CN); Wenrui Li, Beijing (CN); Yu Zou, Beijing (CN); Dan Li, Beijing (CN); Peng Liu, Beijing (CN); Wei Lin, Beijing (CN)

(21) Appl. No.: 14/981,471

(22) Filed: Dec. 28, 2015

(30) Foreign Application Priority Data
Oct. 21, 2015 (CN) 201510689773.X

(51) Int. Cl. H04L 9/14; H04L 12/66; H04L 29/06; H04L 29/08

(52) U.S. Cl. CPC H04L 9/14; H04L 67/12; H04L 12/66; H04L 63/06

(57) ABSTRACT

Embodiments of the present disclosure provide a data communication method, system and gateway for an in-vehicle network including a plurality of subnets. In some embodiments, the data communication method for the in-vehicle network including a plurality of subnets includes: obtaining a first encrypted message sent by a communication device of a first subnet to a second subnet; decrypting the first encrypted message by using a preset first subnet security key to obtain first message data; converting the first message data into second message data conforming to a second subnet communication protocol; encrypting the second message data by using a preset second subnet security key to obtain a second encrypted message; sending the second encrypted message to a corresponding communication device in the second subnet.

### CROSS-REFERENCE TO RELATED APPLICATIONS

This application claims the benefit of Chinese Patent Application No. 201510689773X, filed on Oct. 21, 2015, and which is hereby incorporated by reference in its entirety.

### BACKGROUND

Field of Invention

The present disclosure relates to the field of in-vehicle network communication technology, and more particular to a data communication method, system and gateway for an in-vehicle network including a plurality of subnets.

Description of Related Art

As we all know, a vehicle is composed of four systems including an engine, a chassis, a body and an electric appliance. Each system includes a plurality of communication devices, and an electronic control unit (Electronic Control Unit, ECU) is built in each communication device. From the perspective of use, the ECU is an automotive dedicated microcomputer controller, also known as an automotive dedicated single chip. The ECUs need to communicate and depend on a variety of different bus protocols. Therefore, the interior of the vehicle includes a variety of bus protocols, such as a controller area network (Controller Area Network, CAN) bus protocol, a local interconnect network (Local Interconnect Network, LIN) bus protocol, a media oriented system transport (Media Oriented System Transport, MOST) bus protocol, a FLEXRAY bus protocol, an Ethernet (ETHERNET) bus protocol, etc.

FIG. 1 shows a first exemplary schematic diagram of an in-vehicle network in the prior art, and FIG. 2 shows a second exemplary schematic diagram of an in-vehicle network in the prior art. Referring to FIG. 1 and FIG. 2, a central node of the in-vehicle network is an in-vehicle gateway. The in-vehicle gateway is provided with a variety of interfaces and can be connected to a multi meshed network applicable to such protocols as CAN, LIN, MOST, etc. Each bus protocol constitutes an independent subnet (e.g., a subnet 1), and each subnet contains a certain number of the above-mentioned communication devices.

With the continuous increase of attention of people to vehicle security, and an information security problem is a problem that is not well solved in the in-vehicle network. Based on the topological structure of the above-mentioned in-vehicle network, as shown in FIG. 1, when a message of the subnet 1 is transmitted to a subnet 2, the message needs to be forwarded once at the gateway. In the process, all messages P(n) are transmitted in a plaintext form. However, the messages in the plaintext form can be monitored and broken easily, thereby bringing potential security hazards to vehicle driving.

### SUMMARY

The purpose of one or more disclosed embodiments is to provide a data communication method, system and gateway for an in-vehicle network including a plurality of subnets, so that messages transmitted between the subnets communicate in a ciphertext form to establish a safer and more stable network environment for vehicle driving.

To fulfill the above purpose, embodiments of the present disclosure provide a data communication method for an in-vehicle network including a plurality of subnets, including: obtaining a first encrypted message sent by a communication device of a first subnet to a second subnet; decrypting the first encrypted message by using a preset first subnet security key to obtain first message data; converting the first message data into second message data conforming to a second subnet communication protocol; encrypting the second message data by using a preset second subnet security key to obtain a second encrypted message; sending the second encrypted message to a corresponding communication device in the second subnet.

According to one or more embodiments, the preset first subnet security key and the preset second subnet security key are different.

According to one or more embodiments, the processing of decrypting the first encrypted message by using the preset first subnet security key to obtain the first message data includes: decrypting the first encrypted message by using a symmetric encryption algorithm according to the preset first subnet security key to obtain the first message data, and the processing of encrypting the second message data by using the preset second subnet security key to obtain the second encrypted message includes: encrypting the second message data by using the symmetric encryption algorithm according to the preset second subnet security key to obtain the second encrypted message.

According to one or more embodiments, the symmetric encryption algorithm is a Data Encryption Standard DES algorithm or an Advanced Encryption Standard AES algorithm.

According to one or more embodiments, the method further includes: updating the first subnet security key according to a preset key updating algorithm, and sending the updated first subnet security key to the communication device in the first subnet.

According to one or more embodiments, the processing of sending the updated first subnet security key to the communication device in the first subnet includes: encrypting a key updating message by using the current first subnet security key, wherein the key updating message includes the updated first subnet security key, and sending the encrypted key updating message to the communication device in the first subnet.

According to one or more embodiments, the method is executed by a gateway of the in-vehicle network.

Embodiments of the present disclosure further provide a gateway of an in-vehicle network, including: a message obtaining module, configured to obtain a first encrypted message sent by a communication device of a first subnet to a second subnet; a message decrypting module, configured to decrypt the first encrypted message by using a preset first subnet security key to obtain first message data; a communication protocol converting module, configured to convert the first message data into second message data conforming to a second subnet communication protocol; a message encrypting module, configured to encrypt the second message data by using a preset second subnet security key to obtain a second encrypted message; and a message sending module, configured to send the second encrypted message to a corresponding communication device in the second subnet.

According to one or more embodiments, the preset first subnet security key and the preset second subnet security key are different.

According to one or more embodiments, the message decrypting module is configured to decrypt the first encrypted message by using a symmetric encryption algorithm according to the preset first subnet security key to obtain the first message data, and the message encrypting module is configured to encrypt the second message data by using the symmetric encryption algorithm according to the preset second subnet security key to obtain the second encrypted message.

According to one or more embodiments, the symmetric encryption algorithm is a Data Encryption Standard DES algorithm or an Advanced Encryption Standard AES algorithm.

According to one or more embodiments, the gateway further includes: a key updating module, configured to obtain an updated first subnet security key according to a preset key updating algorithm, and a key sending module, configured to send the updated first subnet security key to the communication device in the first subnet.

According to one or more embodiments, the key sending module includes: a key updating message encrypting unit, configured to encrypt a key updating message by using the current first subnet security key, wherein the key updating message includes the updated first subnet security key, and a key updating message sending unit, configured to send the encrypted key updating message to the communication device in the first subnet.

Embodiments of the present disclosure further provide a data communication system of an in-vehicle network, including: a plurality of subnets and the gateway of the in-vehicle network in the aforementioned embodiment, wherein each subnet includes a plurality of communication devices, and each communication device is used for receiving an encrypted first message from the gateway, decrypting the first message, encrypting a second message sent to the gateway, and sending the encrypted second message to the gateway.

According to one or more embodiments, the data communication method, system and gateway for the in-vehicle network including a plurality of subnets provided by the embodiments of the present disclosure can be used for automatically and quickly encrypting and decrypting messages transmitted between the communication devices of two subnets which execute data communication, so as to ensure safer and more reliable interaction. Wherein, the subnet security keys greatly guarantee the interaction security and stability between the communication devices of the subnets and greatly improve the vehicle driving experience of users.

### BRIEF DESCRIPTION OF THE DRAWINGS

FIG. 1 shows a first exemplary schematic diagram of an in-vehicle network in the prior art.

FIG. 2 shows a second exemplary schematic diagram of an in-vehicle network in the prior art.

FIG. 3 shows a schematic diagram according to one or more embodiments.

FIG. 4 shows a flowchart of a data communication method for an in-vehicle network including a plurality of subnets in a first embodiment of the present disclosure.

FIG. 5 shows a logic block diagram of a gateway of an in-vehicle network in a second embodiment of the present disclosure.

FIG. 6 shows a logic block diagram of a data communication system of an in-vehicle network in a third embodiment of the present disclosure.

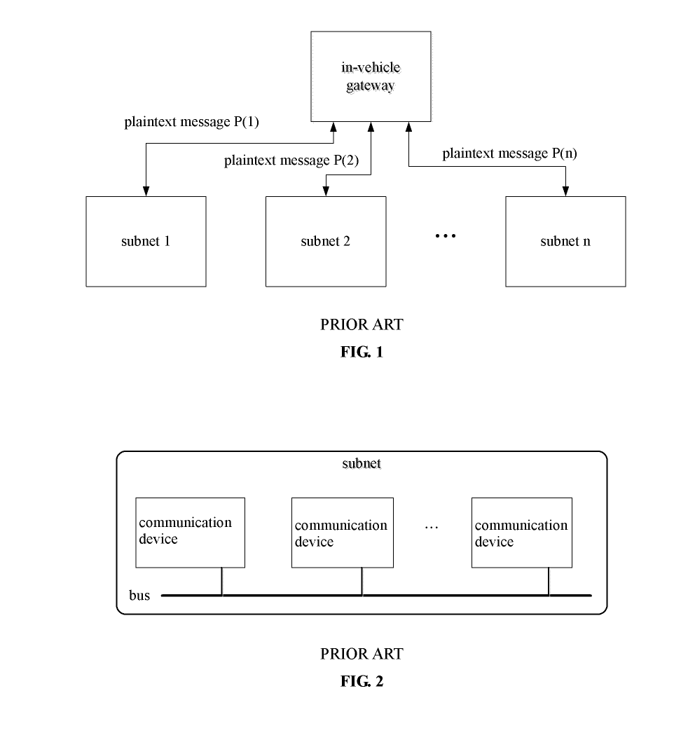

### DETAILED DESCRIPTION

The basic concept of one or more embodiments of the present invention is to provide a technical solution for encrypting and decrypting a message transmitted between two subnets which execute data communication based on security keys and transmitting the message, so as to ensure safer and more reliable interaction between communication devices of the subnets.

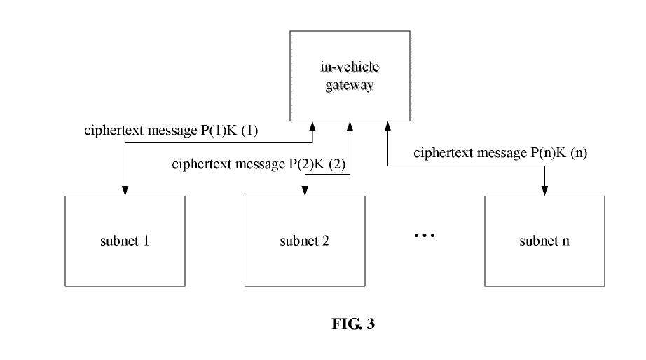

FIG. 3 shows a schematic diagram according to one or more embodiments.

Referring to FIG. 3, keys corresponding to various subnets are stored in an in-vehicle gateway, and when one message needs to be transmitted from a subnet 1 to a subnet 2, an encrypted message of the subnet 1 may use a communication protocol different from that of the encrypted message of the subnet 2.

For example, the in-vehicle gateway receives a ciphertext message P(1)K(1) from the subnet 1, analyzes the ciphertext message P(1)K(1) by using a key K(1) of the subnet 1 to obtain message data P(1), performs communication protocol conversion of different subnets on the message data P(1) to convert the same into message data P(2) conforming to the communication protocol of the subnet 2, finally encrypts the communication protocol converted message data P(2) by using a key K(2) of the subnet 2 to obtain a ciphertext message P(2)K(2), and sends the ciphertext message P(2)K(2) to the subnet 2.

Therefore, in a data communication process in the in-vehicle network, the messages are transmitted in a ciphertext form, and the messages in the ciphertext form have the advantages of being unlikely to monitor and break. Therefore, data communication is performed in the in-vehicle network in the ciphertext form to guarantee the interaction security and stability between the communication devices of the subnets and improve the vehicle driving security, so as to improve the vehicle driving experience of users.

In addition, since the communication devices of the subnets adopt different keys, even if a certain subnet is broken, the other subnets will not be influenced, and the other subnets are still secure.

The data communication method, system and gateway for the in-vehicle network including a plurality of subnets provided by the embodiments of the present disclosure will be described below in detail in combination with the accompanying drawings.

### A First Embodiment

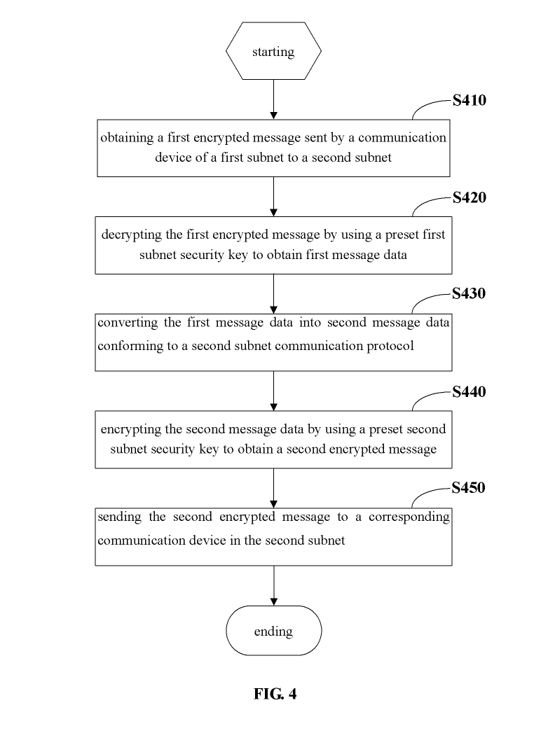

FIG. 4 shows a flowchart of a data communication method for an in-vehicle network including a plurality of subnets in a first embodiment of the present disclosure. For example, the method can be executed by a gateway of the in-vehicle network.

Referring to FIG. 4, in a step S410, a first encrypted message sent by a communication device of a first subnet to a second subnet is obtained.

Specifically, when the communication device of the first subnet needs to perform data communication with the communication device of the second subnet, the communication device of the first subnet will use a pre-stored preset first subnet security key to encrypt message data to obtain the first encrypted message and send the first encrypted message on a bus. Correspondingly, the gateway of the in-vehicle network obtains the first encrypted message from the bus. Herein, the length of the subnet security key can be 128 bits or 256 bits.

In a step S420, the first encrypted message is decrypted by using the preset first subnet security key to obtain first message data.

In a specific implementation manner, the preset first subnet security key can be pre-stored in the gateway of the in-vehicle network and the communication device of the first subnet, when in use, the preset first subnet security key is directly obtained or is downloaded from a server storing a variety of subnet security keys or is directly copied from such storage devices as a USB disk or the like. Likewise, for the in-vehicle network including a plurality of subnets, the same implementation manner can also be applied to the security keys of other subnets.

In a step S430, the first message data are converted into second message data conforming to a second subnet communication protocol;

In a step S440, the second message data are encrypted by using a preset second subnet security key to obtain a second encrypted message.

In a step S450, the second encrypted message is sent to a corresponding communication device in the second subnet.

According to the data communication method for the in-vehicle network including a plurality of subnets in the embodiment of the present disclosure, the encrypted message sent by a communication initiator is received, and decryption, communication protocol conversion and encryption are further performed on the encrypted message, so as to automatically and quickly send the encrypted message suitable for the communication initiator, greatly guarantee the interaction security, smoothness and stability between the communication devices of the subnets and improve the vehicle driving experience of users.

On this basis, since in the device of the in-vehicle network, requirements on system feedback and resource use are higher, it can be considered that a used encryption and decryption algorithm is optimized. In the encryption and decryption algorithm, a symmetric encryption algorithm has the advantages of being relatively simple and low in system overhead, thereby being suitable for encryption and decryption of a large amount of data.

Therefore, according to the exemplary embodiment of the present disclosure, in the step S420, the first encrypted message is decrypted by using the symmetric encryption algorithm according to the preset first subnet security key to obtain the first message data.

Similarly, according to the exemplary embodiment of the present disclosure, in the step S440, the second message data are encrypted by using the symmetric encryption algorithm according to the preset second subnet security key to obtain the second encrypted message.

Further, the symmetric encryption algorithm can be a Data Encryption Standard DES algorithm or an Advanced Encryption Standard AES algorithm, so that the adopted encryption algorithm is further optimized. Wherein the Data Encryption Standard DES algorithm has a higher operating speed, thereby being suitable for occasions in which a large amount of data are encrypted, while the Advanced Encryption Standard AES algorithm is a next generation encryption algorithm standard, the operating speed thereof is higher than that of the Data Encryption Standard DES algorithm, and the security level is high.

In addition, according to an embodiment of the present disclosure, the preset first subnet security key and the preset second subnet security key are different.

For example, the second encrypted message is sent to the bus of the second subnet for transmission. The corresponding communication device in the second subnet obtains the second encrypted message from the bus. Even if the second encrypted message is monitored by an illegal node, since the node does not have the key of the second subnet, the node cannot analyze the message data, let alone backwards deducing the meaning of each field in the message. Therefore, the monitored second encrypted message has no value.

In a specific implementation manner, the subnets use different security keys. These security keys are used as initial keys before the vehicle is delivered and are implanted in the gateway of the in-vehicle network and ECUs in the communication devices for the first time. Since the key leakage probability in a vehicle factory is very small, the security of the initial keys is ensured.

However, the security has hidden troubles in the subsequent vehicle driving process, therefore, the security keys used by different subnets need to be updated periodically, and the updating process is managed by the gateway of the in-vehicle network. For example, after the security keys are due, the gateway needs to send key updating messages to the subnets, and the key updating messages carry new keys. The key updating messages also need to be transmitted in the ciphertext form, the key updating messages can be encrypted by old keys, and then the key updating messages are sent to the buses of the subnets, for example in a broadcasting manner. The ECUs in the communication devices in the subnets obtain the key updating messages from the buses of the affiliated subnets, the key updating messages are decrypted by the old keys to obtain the new keys, and the new keys are further stored. In a similar way, the gateway sequentially performs the above-mentioned key updating processing on different subnets one by one.

Therefore, the method can further include: updating the first subnet security key according to a preset key updating algorithm, and sending the updated first subnet security key to the communication device in the first subnet.

Specifically, the updated first subnet security key is obtained by using the key updating algorithm; then, the key updating message is encrypted by using the current first subnet security key, wherein the key updating message includes the updated first subnet security key, and the encrypted key updating message is sent to the communication device in the first subnet.

### A Second Embodiment

FIG. 5 shows a logic block diagram of a gateway of an in-vehicle network in a second embodiment of the present disclosure. The gateway can be used for executing the steps of the method in the embodiment as shown in FIG. 4.

Referring to FIG. 5, the gateway of the in-vehicle network includes a message obtaining module 510, a message decrypting module 520, a communication protocol converting module 530, a message encrypting module 540 and a message sending module 550.

The message obtaining module 510 is configured to obtain a first encrypted message sent by a communication device of a first subnet to a second subnet.

The message decrypting module 520 is configured to decrypt the first encrypted message by using a preset first subnet security key to obtain first message data.

Specifically, the message decrypting module 520 can be configured to decrypt the first encrypted message by using a symmetric encryption algorithm according to the preset first subnet security key to obtain the first message data.

Herein, the symmetric encryption algorithm can be a Data Encryption Standard DES algorithm or an Advanced Encryption Standard AES algorithm.

The communication protocol converting module 530 is configured to convert the first message data into second message data conforming to a second subnet communication protocol.

The message encrypting module 540 is configured to encrypt the second message data by using a preset second subnet security key to obtain a second encrypted message.

Specifically, the message encrypting module 540 can be configured to encrypt the second message data by using the symmetric encryption algorithm according to the preset second subnet security key to obtain the second encrypted message.

The message sending module 550 is configured to send the second encrypted message to a corresponding communication device in the second subnet.

Preferably, the preset first subnet security key and the preset second subnet security key are different.

Further, the gateway can further include: a key updating module (not shown), configured to obtain an updated first subnet security key according to a preset key updating algorithm; and a key sending module (not shown), configured to send the updated first subnet security key to the communication device in the first subnet.

Furthermore, the key sending module can include: a key updating message encrypting unit (not shown), configured to encrypt a key updating message by using the current first subnet security key, wherein the key updating message includes the updated first subnet security key; and a key updating message sending unit (not shown), configured to send the encrypted key updating message to the communication device in the first subnet.

The gateway of the in-vehicle network provided by the embodiment of the present disclosure can decrypt the encrypted message sent by a communication initiator according to the security key of the affiliated subnet of the communication device of the communication initiator, perform communication protocol conversion on the message data obtained by decryption, encrypt the converted message data by using the security key of the affiliated subnet of the communication device of a communication receiver and send the message data to the communication device of the communication receiver, so as to guarantee a safer and more reliable interaction process. Particularly, the subnet security keys greatly guarantee the interaction security and stability between the communication devices of the subnets and improve the vehicle driving experience of users.

### A Third Embodiment

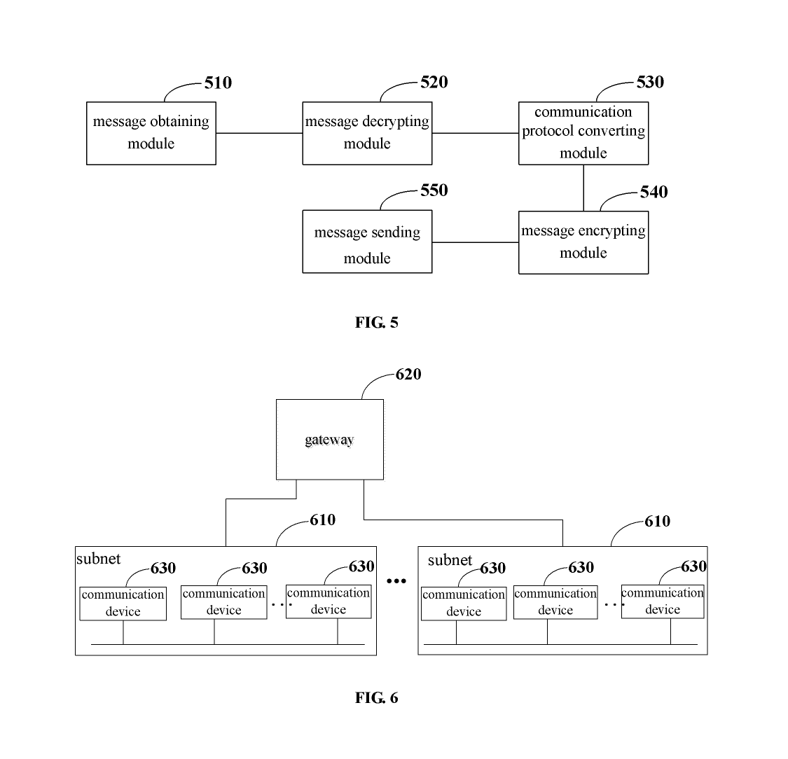

FIG. 6 shows a logic block diagram of a data communication system of an in-vehicle network in a third embodiment of the present disclosure.

Referring to FIG. 6, the data communication system includes a plurality of subnets 610 and the gateway 620 of the in-vehicle network in the aforementioned second embodiment, wherein each subnet 610 includes a plurality of communication devices 630.

Each communication device 630 is used for receiving an encrypted first message from the gateway, decrypting the first message, encrypting a second message sent to the gateway, and sending the encrypted second message to the gateway.

The data communication system of the in-vehicle network provided by the embodiment of the present disclosure can be used for automatically and quickly encrypting and decrypting the message transmitted by the communication initiator to the gateway and the message transmitted by the gateway to the communication receiver for the communication devices of two subnets which execute data communication, so as to provide a safer and more reliable data communication environment for the gateway of the in-vehicle network and a plurality of subnets and greatly improve the vehicle driving experience of users.

### A Forth Embodiment

A gateway of an in-vehicle network, including: a processor; and a memory for storing instructions executable by the processor; wherein the processor is configured to: obtain a first encrypted message sent by a communication device of a first subnet to a second subnet; decrypt the first encrypted message by using a preset first subnet security key to obtain first message data; convert the first message data into second message data conforming to a second subnet communication protocol; encrypt the second message data by using a preset second subnet security key to obtain a second encrypted message; and send the second encrypted message to a corresponding communication device in the second subnet.

Wherein the preset first subnet security key and the preset second subnet security key are different.

Wherein the processor is further configured to: decrypt the first encrypted message by using a symmetric encryption algorithm according to the preset first subnet security key to obtain the first message data; and encrypt the second message data by using the symmetric encryption algorithm according to the preset second subnet security key to obtain the second encrypted message.

Wherein the symmetric encryption algorithm is a Data Encryption Standard DES algorithm or an Advanced Encryption Standard AES algorithm.

Wherein the processor is further configured to: obtain an updated first subnet security key according to a preset key updating algorithm; and send the updated first subnet security key to the communication device in the first subnet.

Wherein the processor is further configured to: encrypt a key updating message by using the current first subnet security key, wherein the key updating message includes the updated first subnet security key; and send the encrypted key updating message to the communication device in the first subnet.

A data communication system of an in-vehicle network includes: a plurality of subnets and the gateway of the in-vehicle network disclosed above, wherein each subnet includes a plurality of communication devices, and each communication device is configured to: receive an encrypted first message from the gateway; decrypt the first message; encrypt a second message sent to the gateway; and send the encrypted second message to the gateway.

In the several embodiments provided by the present disclosure, it should be understood that, the disclosed server and method can be implemented in other manners. For example, the server embodiments described above are merely exemplary, e.g., the division of the modules is only a logic function division, and other division manners can exist in practical implementation.

In addition, the functional modules in the embodiments of the present disclosure can be integrated in a processing module, or the modules can singly exist physically, or two or more modules are integrated in one module. The above-mentioned integrated module can be implemented in the form of hardware and can be also be implemented in the form of hardware and a software functional module.

The integrated module implemented in the form of the software functional module can be stored in a computer readable storage medium. The software functional module is stored in a storage medium, and includes a plurality of instructions enabling a computer device (can be a personal computer, a server, a network device or the like) or a processor (processor) to execute a part of steps of the method in the embodiments of the present disclosure. The foregoing storage medium includes a variety of media capable of storing program codes, such as a USB disk, a mobile hard disk, a read-only memory (Read-Only Memory, ROM), a random access memory (Random Access Memory, RAM), a magnetic disk, an optical disk or the like.

The foregoing descriptions are merely specific implementations of the present disclosure, but the protection scope of the present disclosure is not limited hereto. Any skilled one who is familiar with this art could readily think of variations or substitutions within the disclosed technical scope of the present disclosure, and these variations or substitutions shall fall within the protection scope of the present disclosure. Accordingly, the protection scope of the claims should prevail over the protection scope of the present disclosure.

What is claimed is:

1. A data communication method for an in-vehicle network comprising a plurality of subnets, the data communication method comprising:
obtaining a first encrypted message sent from a communication device of a first subnet to a second subnet;
decrypting the first encrypted message by using a preset first subnet security key to obtain first message data;
converting the first message data into second message data conforming to a second subnet communication protocol;
encrypting the second message data by using a preset second subnet security key to obtain a second encrypted message; and
sending the second encrypted message to a corresponding communication device in the second subnet.

2. The method of claim 1, wherein the preset first subnet security key and the preset second subnet security key are different.

3. The method of claim 2,
wherein decrypting the first encrypted message by using the preset first subnet security key to obtain the first message data comprises:
decrypting the first encrypted message by using a symmetric encryption algorithm according to the preset first subnet security key to obtain the first message data; and
wherein encrypting the second message data by using the preset second subnet security key to obtain the second encrypted message comprises:
encrypting the second message data by using the symmetric encryption algorithm according to the preset second subnet security key to obtain the second encrypted message.

4. The method of claim 3, wherein the symmetric encryption algorithm is a Data Encryption Standard algorithm or an Advanced Encryption Standard algorithm.

5. The method of claim 1, further comprising:
updating the present first subnet security key according to a preset key updating algorithm; and
sending the updated present first subnet security key to the communication device in the first subnet.

6. The method of claim 2, further comprising:
updating the present first subnet security key according to a preset key updating algorithm; and
sending the updated first subnet security key to the communication device in the first subnet.

7. The method of claim 5, wherein the processing of sending the updated first subnet security key to the communication device in the first subnet comprises:
encrypting a key updating message by using the current first subnet security key, wherein the key updating message comprises the updated first subnet security key; and
sending the encrypted key updating message to the communication device in the first subnet.

8. The method of claim 6, wherein the processing of sending the updated first subnet security key to the communication device in the first subnet comprises:
encrypting a key updating message by using the current first subnet security key, wherein the key updating message comprises the updated first subnet security key; and
sending the encrypted key updating message to the communication device in the first subnet.

9. The method of claim 7, wherein the method is executed by a gateway of the in-vehicle network.

10. A gateway of an in-vehicle network, comprising:
a processor; and
a memory for storing instructions executable by the processor;
wherein the processor is configured to:
obtain a first encrypted message sent by a communication device of a first subnet to a second subnet;
decrypt the first encrypted message by using a preset first subnet security key to obtain first message data;
convert the first message data into second message data conforming to a second subnet communication protocol;
encrypt the second message data by using a preset second subnet security key to obtain a second encrypted message; and
send the second encrypted message to a corresponding communication device in the second subnet.

11. The gateway of claim 10, wherein the preset first subnet security key and the preset second subnet security key are different.

12. The gateway of claim 11, wherein the processor is further configured to:
decrypt the first encrypted message by using a symmetric encryption algorithm according to the preset first subnet security key to obtain the first message data; and
encrypt the second message data by using the symmetric encryption algorithm according to the preset second subnet security key to obtain the second encrypted message.

13. The gateway of claim 14, wherein the symmetric encryption algorithm is a Data Encryption Standard DES algorithm or an Advanced Encryption Standard AES algorithm.

14. The gateway of claim 10, wherein the processor is further configured to:
obtain an updated first subnet security key according to a preset key updating algorithm; and
send the updated first subnet security key to the communication device in the first subnet.

15. The gateway of claim 14, wherein the processor is further configured to:
encrypt a key updating message by using the current first subnet security key, wherein the key updating message comprises the updated first subnet security key; and
send the encrypted key updating message to the communication device in the first subnet.

16. A data communication system of an in-vehicle network comprises: a plurality of subnets and a gateway of an in-vehicle network, wherein each subnet comprises a plurality of communication devices, and each communication device is configured to:
receive an encrypted first message from the gateway;
decrypt the first message;
encrypt a second message to be sent to the gateway; and
send the encrypted second message to the gateway.
